(19) United States
(12) Patent Application Publication
(10) Pub. No.: US 2017/0341789 A1
(43) Pub. Date: Nov. 30, 2017

(54) WRAPPED FOOD PRODUCT AND PROCESS FOR THE PRODUCTION OF A PACKAGED FOOD PRODUCT

(71) Applicant: PASSEPARTOUT CAFFE' S.R.L., Roma (RM) (IT)

(72) Inventors: Pietro DONATI, San Giovanni in Marignano (Rimini) (IT); Marco VERRI, Ozzano dell'Emilia Bologna (IT)

(21) Appl. No.: 15/536,888

(22) PCT Filed: Dec. 15, 2015
(86) PCT No.: PCT/IB2015/059619

§ 371 Date: Jun. 16, 2017

(30) Foreign Application Priority Data
Dec. 16, 2014 (IT) BO2014A000702
Jan. 15, 2015 (IT) BO2015U000003
May 26, 2015 (IT) 202015000017965

(51) Int. Cl. B65B 29/02; B65D 75/04; B65D 65/46; A23F 5/12; A23F 3/32; B65B 1/22; A23L 2/395; B65D 85/808; B65B 11/00

(52) U.S. Cl. CPC B65B 29/025; B65D 85/808; B65D 75/04; B65D 65/466; B65B 11/004; A23F 3/32; B65B 1/22; A23L 2/395; A23F 5/125; A23V 2002/00

(57) ABSTRACT

A wrapped food product, the food product being preferably in the form of an infusion product, in particular in the form of a material in the form of powder, granules or pieces, such as tea, camomile, coffee or other, wrapped in a respective wrapper; the wrapper being made of biodegradable and/or organic film, which is wrapped around and closely connected, or adherent, to the material.

### TECHNICAL FIELD

This invention relates to a wrapped food product and a process for the production of a packaged food product.

### BACKGROUND ART

Packages of infusion material for making beverages, in particular tea, are known in the prior art wherein the loose material is packaged in a bag of biodegradable organic material, such as polyactic acid, and it is used by placing it in infusion in a corresponding cup of hot water. After having been used, the tea bags made of biodegradable material can be disposed of in the organic waste collection container, without any concern regarding the biodegradability of the package.

However this type of packages has a limited use and the consistency of the package is such as to not allow it to be used inside respective infusion machines, in which the material must be inserted in a stationary manner in a respective seat of the machine in which the infusion process occurs.

In practice, the use of the package is limited to uses which require the direct immersion of the bag in the cup which contains the hot water.

There are also prior art pods for infusion material, in particular coffee, which have a rigid consistency that does not allow the use in corresponding infusion machines and wherein the package is defined by an outer case made of aluminium foil, which compresses and firmly holds the material housed inside. In these packages of coffee the outer wrapper is made of non-biodegradable material, and therefore, although containing perfectly compostable product, the package in its entirety cannot be disposed of as waste in a container for collecting organic waste.

Thus, the need is currently felt for having pods or packaged products which can be easily placed as waste in the organic waste container and which at the same time can be easily used for example in respective infusion machines.

The need is also felt of having packages for food products which can be easily used, made, and/or which are of limited cost.

### SUMMARY OF THE INVENTION

This invention therefore proposes a new solution as an alternative to the solutions known up to now and, more specifically, proposes to overcome one or more of the above mentioned drawbacks or problems and/or to meet one or more of the needs felt in the trade or inferable from the above.

Accordingly, a wrapped food product is provided, the food product being preferably in the form of an infusion product to obtain a respective beverage, and in particular in the form of a material in the form of powder, granules or pieces, such as coffee, tea, camomile, herbal tea, milk, chocolate or other, wrapped in a respective wrapper; characterised in that the wrapper is made of biodegradable and/or organic film, which is wrapped around and is preferably closely connected, or adherent, to the material.

In this way, it is possible make a package which is entirely compostable and wherein the outer film contains in an efficient manner the material housed therein and which may be advantageously also used directly in corresponding infusion machines.

### BRIEF DESCRIPTION OF THE DRAWINGS

These and other innovative aspects, or specific advantageous features, are set out in the appended claims and its technical features and advantages are apparent from the detailed description which follows of a preferred, advantageous embodiment of it, which must be considered purely as a non-limiting example. the description being made with reference to the accompanying drawings, in which:

FIG. 1 is a perspective view of a preferred embodiment of the product in accordance with this invention;

FIG. 2 is a bottom plan view of the preferred embodiment of the product in accordance with this invention;

FIG. 3 is a top plan view of the preferred embodiment of the product in accordance with this invention;

FIG. 4 shows a top plan view of this product before the final forming processing;

FIG. 5 is a side view corresponding to the product of FIG. 4;

FIGS. 6 and 7 are respective schematic side views of different steps of the process for forming this product;

FIG. 8 is a perspective view of a second preferred embodiment of the packaged food product according to this invention.

### DETAILED DESCRIPTION OF PREFERRED EMBODIMENTS OF THE INVENTION

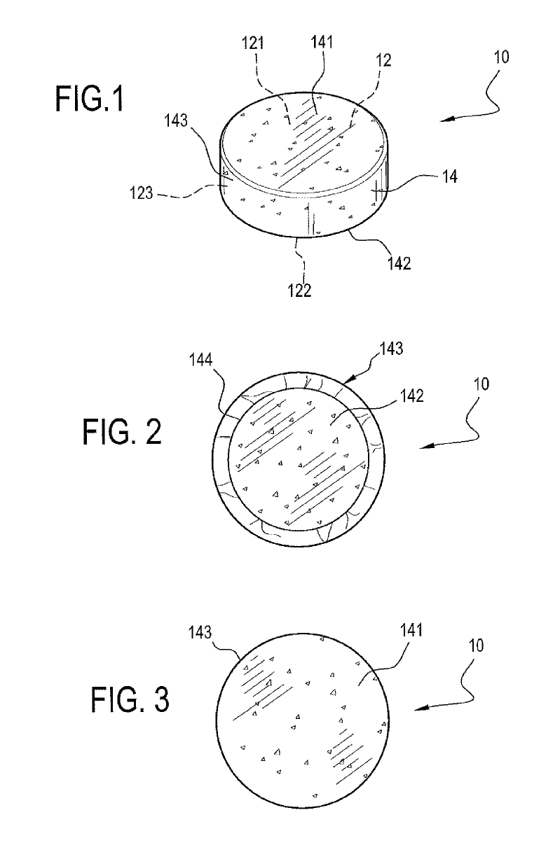

FIG. 1 illustrates a preferred embodiment 10 of wrapped food product, the food product preferably being in the form an infusion product in water, in particular which can be carried out in specific infusion machines, for example infusion machines for household use, to obtain an beverage, in particular a hot beverage.

As may also be inferred from FIGS. 2 to 5, this wrapped food product 10 is in the form of a material in the form of powder, granules or pieces, such as coffee, tea, camomile, or another, which is wrapped in a respective wrapper 14.

However, it will be understood that the food product could also consist of herbal tea, milk, chocolate or others.

Advantageously, the wrapper 14 is made of filtering film, the filtering film being wrapped around and closely connected, or adherent, to the material 12.

The film made of filtering material 14 is permeable to the passage of the infusion liquid and is in the form of a film made of biodegradable and/or compostable and/or organic material, preferably made of polyactic acid or PLA.

Preferably, a filtering film is used, preferably made of PLA, having a weight per square metre of between 80 mg and 110 mg.

Further advantageously, the infusion material is configured like a rigid and compact tablet.

The product is in the form of a product which may be advantageously placed as waste in containers for organic or compostable waste and which may be ready for use, inside respective seats of infusion machines.

Also, advantageously, the wrapped food product is such as to not let drop any residual powder or granules or pieces of the material and it is therefore practical to use and especially desirable.

More specifically, as illustrated, the material 12 has a respective outer surface, preferably comprising opposite transversal end faces, or surfaces, respectively, 121 and 122, and a peripheral surface 123, extending between the opposite transversal end surfaces 121, 122 and, in particular, as illustrated, having an outer circumferential or cylindrical surface 123.

As illustrated, in turn, the transversal end faces 121, 122 are in the form of respective substantially flat surfaces, preferably with a circular perimeter.

More specifically, the wrapper 14 is closely connected, or adherent, to one or more of the outer surfaces of the product, and preferably to the entire outer surface of the product.

For this reason, the wrapper 14 has opposite transversal layers 141, 142 superposing the corresponding transversal end surface 121, 122 of the material 12 and a peripheral surface 143 superposing the corresponding peripheral surface 123 of the material 12.

Advantageously, as mentioned, the wrapper 14 is closely connected, or adherent, to one or more of the outer surfaces of the material, in particular to one or both of the corresponding transversal end surfaces 121, 122 of the material 12 and/or the peripheral surface 123 of the material 12, and preferably is closely connected, or adherent, to the entire outer surface of the material 12.

More specifically, as illustrated, the wrapper 14 has a layer 144 superposing an underlying layer 142 which is closely connected, or adherent, to the material.

More specifically, the layer 144 superposing 142 which is closely connected, or adherent, to the material, is in turn adherent, or connected, to the underlying layer 142 of the wrapper which is closely connected or adherent to the corresponding surface or face of material 122.

More specifically, the layer 144 superposing a closely connected, or adherent underlying layer 142 extends, starting from the respective peripheral edge, for a certain circumferential stretch superposing a layer 142 at the transversal end surface 122 of the material.

As may be inferred, the respective end face of the material and/or the corresponding layer of the closely connected wrapper, in particular both the transversal end faces 121, 122 of the material and/or the corresponding layers 141, 142 of the closely connected wrapper, are in the form of a respective substantially flat surface, preferably with an outer circular profile.

In turn, the perimetric surface of the material 123 and/or of the corresponding superposed layer 143 of the closely connected wrapper is in the form of a surface having a generally cylindrical shape.

Although not specifically illustrated in the accompanying drawings, this wrapped product 10 may be inserted in a corresponding secondary packing, preferably consisting of a second wrapper made of aluminium foil.

In this way, it is possible to maintain the fragrance of the packaged product 10, removing the outer wrapper at the time of using the product 10 in a suitable machine, then disposing of the product as waste in the container for biodegradable waste and the outer packaging, preferably made of aluminium, in another container.

Preferably, the material contained is defined by coffee, in particular in the form of toasted and ground coffee.

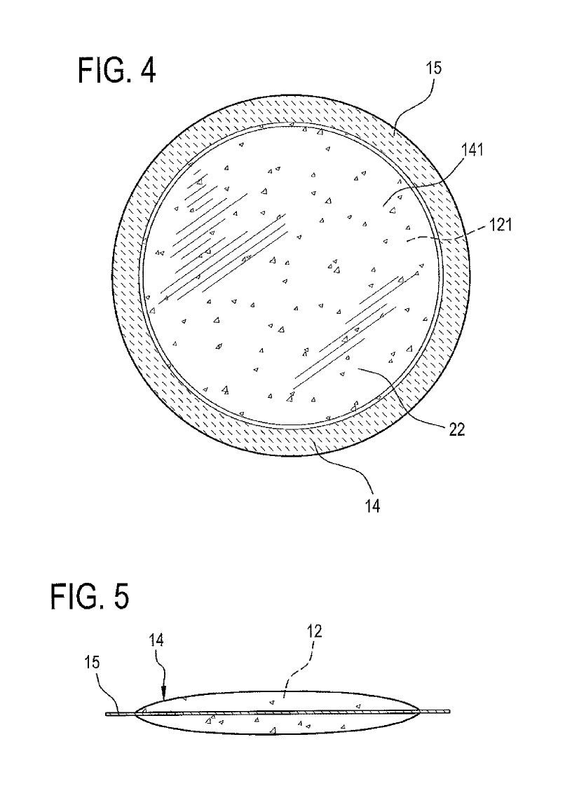

With reference also to FIGS. 4 to 7, an advantageous process may be inferred for making a wrapped food product 10, wherein the food material 12 is preferably in the form an infusion product, in particular in the form of a material in the form of powder, granules or pieces, such as coffee, tea, camomile, herbal tea, milk, chocolate or other, with a predetermined portion of the material introduced inside a respective wrapper, the wrapper being in the form of a corresponding film of biodegradable and/or organic material, preferably made of polyactic acid or PLA.

The material which is introduced inside the wrapper 14 is preferably in a loose and/or substantially non-aggregated condition.

According to the process, energy is supplied to the wrapper 14 with the material contained 12 until connecting closely, or adhering, the wrapper 14 to the wrapper 12.

Preferably, the material processed according to this invention, that is, the material contained in the wrapper, is defined by coffee, in particular in the form of toasted and ground coffee.

Advantageously, by means of the energy supplied to the wrapper 14 with the material contained 12, a rigid and compact tablet of the material 12 is obtained.

Advantageously, according to the process, the energy supplied to the wrapper 14 with the material contained 12 is in the form of vibrational mechanical energy, in particular in the form of ultrasonic energy.

In any case, advantageously, according to the process, the energy supplied to the wrapper 14 with the material contained 12 is such as not to destroy or damage the wrapper 14.

More specifically, vibrational mechanical energy is supplied at a frequency of between 16,000 and 35,000 Hertz.

According to the process, energy is supplied to the wrapper with the material contained at between 500 and 6,000 Joules, preferably between 1,200 and 3,000 Joules, and in particular suitably selectable as a function of the weight of the portion of infusion material processed.

Preferably, the portion of infusion material processed and inserted inside a specific wrapper 14 has a weight of between 5 and 25 g.

However, in certain specific cases, the weight of the portion of infusion material inserted inside the wrapper 14 could also be greater and purely by way of an example the weight of the portion of infusion material processed and inserted inside a specific wrapper 14 could also be around 30 g.

More specifically, according to the process, energy is supplied to the wrapper with the material contained for a time of between 0.5 and 20 seconds, preferably between 2 and 6 seconds.

As illustrated, to form appropriately the packaged food product, according to the process, the wrapper 14 is positioned with the material contained 12 in a respective mould 20 having a respective seat 22 for receiving, or forming, the wrapper 14 with the material contained 12.

According to the process, the wrapper 14 with the product contained 12 is pushed into the respective seat 22 of the mould 20.

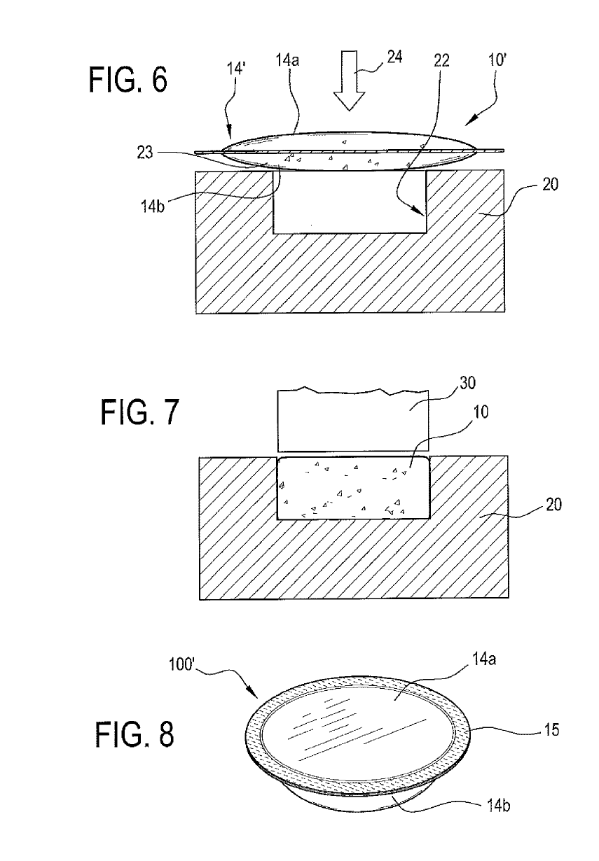

To perform this operation use is made of corresponding pusher means, embodied by way of an example in FIG. 6 by a corresponding arrow 24.

As may be inferred from FIGS. 6 and 7, the product in the extended condition 10′, that is, the wrapper 14 with the material contained 12, before inserting into the respective seat 22 of the mould 20, protrudes peripherally beyond the inlet opening 23 in the seat 22, and following the insertion in the seat of the mould has at least one peripheral end portion 144 of the protruding portion of the wrapper which superposes a layer 142 of the wrapper which is in direct contact with the material contained 12, that is, of a layer 142 which engages an end transversal face 122 of the material.

As illustrated, advantageously, the wrapper 14, in particular before inserting in the mould 20, hermetically contains the material contained.

Subsequently, the means for supplying vibrational mechanical energy 30, in particular a sonotrode device, supply energy to the wrapper 14 with the material contained 12 positioned inside the seat 22 of the respective mould 20, in particular until obtaining the wrapped food product, wherein the wrapper is closely connected, or adherent, to the material contained and wherein the material contained is substantially shaped like a rigid and compact tablet.

More specifically, as illustrated, the wrapper 14 comprises respective means 15 for closing the portion of material inside the wrapper.

More specifically, according to this preferred embodiment, the closing means 15 comprise one or more edges superposed and joined to each other, in particular of corresponding layers 14a, 14b of the wrapper.

More specifically, as illustrated, the closing means 15 comprise a first and a second layer 14a, 14b of wrapper having respective peripheral edges superposed and joined to each other to define respective closing means or edge 15.

According to a further embodiment not illustrated in the accompanying drawings, it would also be imaginable that the closing means 15 comprise one or more edges superposed and joined together of a layer or sheet of wrapper, which is wound around the material.

In this case, it is imaginable the closing means comprise respective transversal end edges defined by portions superposed and joined together of the layer of wrapper and a respective longitudinal edge which extends between and from the transversal end edges and which would be defined by lateral end portions superposed and joined together of the sheet or wrapper.

FIG. 8 illustrates a second preferred embodiment of the product in the extended condition 100′, that is, of the wrapper 14 with the material contained 12, before inserting in the respective seat 22 of the mould 20, which has components similar, or equivalent, to those of the preferred embodiment described above, and which are denoted by the same reference numerals and which, for brevity and convenience, are not described again in detail.

The second preferred embodiment of product is obtained preparing a tray of a lower layer 14b the wrapper, in which is provided the food material 12 in loose condition, and applying on this a respective sheet or layer, preferably flat 14a, which is joined to the lower layer 14a along the respective outer perimeter defining corresponding closing means 15.

Basically, according to the respective process of this second preferred embodiment, a lower layer of the wrapper 14b is prepared shaped in the form of a tray, that is, such as to define a respective seat for housing the food material 12 in loose condition, and on this layer shaped like a tray 14b, and containing the food material 12 in loose condition, is applied a respective sheet or layer, preferably flat 14a, which is joined to the lower layer 14b along the respective outer perimeter defining corresponding means 15 of closing the package or wrapper.

### EXAMPLE EMBODIMENT 1

5.5 grams of toasted and ground coffee are introduced, in loose condition, in a wrapper made of PLA, which completely wraps around the coffee and it is all inserted in a suitable mould.

The product is subjected to ultrasonic stress, using a corresponding sonotrode device, which gives off a sound vibration at a frequency of approximately 20,000 Hertz with a predetermined energy equal to 800-900 Joules for a length of time of 2-3 seconds.

A tablet of coated coffee is obtained, having the features illustrated in FIG. 1 and it maintains that configuration permanently, in which the particles of product for infusion are directly connected to or adhering to one another and the outer wrapper made of PLA adheres to the coffee.

### EXAMPLE EMBODIMENT 2

7.5 grams of toasted and ground coffee are introduced, in loose condition, in a wrapper made of PLA, which completely wraps around the coffee and it is all inserted in a suitable mould.

The product is subjected to ultrasonic stress, using a corresponding sonotrode device, which gives off a sound vibration at a frequency of approximately 20,000 Hertz with a predetermined energy equal to 1,300 Joules for a length of time of 4 seconds.

A tablet of coated coffee is obtained, having the features illustrated in FIG. 1 and it maintains that configuration permanently, in which the particles of product for infusion are directly connected to or adhering to one another and the outer wrapper made of PLA adheres to the coffee.

### EXAMPLE EMBODIMENT 3

7.5 grams of toasted and ground coffee are introduced, in loose condition, in a wrapper made of PLA, which completely wraps around the coffee and it is all inserted in a suitable mould.

The product is subjected to ultrasonic stress, using a corresponding sonotrode device, which gives off a sound vibration at a frequency of approximately 20,000 Hertz with a predetermined energy equal to 1,900 Joules for a length of time of 5-6 seconds.

A tablet of coated coffee is obtained, having the features illustrated in FIG. 1 and it maintains that configuration permanently, in which the particles of product for infusion are directly connected to or adhering to one another and the outer wrapper made of PLA adheres to the coffee.

However, it must also be understood that by using levels of ultrasound energy or stress times reduced more than those illustrated above it is in any case possible to obtain an aggregation, even though to a lesser extent, of the particles of raw material or coffee, which allows in any case a product to be obtained which is sufficiently compact and which can be easily used by the end user.

### EXAMPLE EMBODIMENT 4

5.5 grams of toasted and ground coffee are introduced, in loose condition, in a wrapper made of PLA, which completely wraps around the coffee and it is all inserted in a suitable mould.

The product is subjected to ultrasonic stress, using a corresponding sonotrode device, which gives off a sound vibration at a frequency of approximately 20,000 Hertz with a predetermined energy equal to 500-600 Joules for a length of time of 1.5-2 seconds.

A tablet of coated coffee is obtained having particles of product for infusion which are directly connected to or adhering to one another and the outer wrapper made of PLA adheres to the coffee, even though the degree of compaction of the whole is reduced.

It would be obvious to one skilled in the art that several changes and/or modifications can be made to the invention without departing from the spirit and scope of the invention, described in depth above. This embodiment is therefore to be considered, from all points of view, as an example and non-limiting embodiment.

1.-14. (canceled)

15. A process for the production of a packaged food product, wherein the food product is preferably in the form of an infusion product to obtain a respective beverage, and in particular in the form of a material in the form of powder, granules or pieces, such as coffee, tea, camomile, herbal tea, milk, chocolate, or other; wherein a predetermined portion of the material is introduced into a respective wrapper made of biodegradable and/or organic film, and energy is supplied to the wrapper with the material contained, preferably up to making the wrapper closely connect, or adhere, to the material.

16. The process according to claim 15, wherein, by means of the energy supplied to the wrapper with the material contained, a rigid and compact tablet of the material is obtained.

17. The process according to claim 15, wherein the energy supplied to the wrapper with the material contained is in the form of vibrational energy, in particular ultrasonic energy.

18. The process according to claim 15, wherein the wrapper with the material contained is placed in a respective mould having a respective seat for receiving the wrapper with the material contained.

19. The process according to claim 18, and further comprising pushing the wrapper with the product contained into the respective seat of the mould.

20. The process according to claim 18, wherein the wrapper with the material contained, before inserting into the respective seat of the mould, protrudes peripherally beyond the inlet opening of the seat, and following the insertion in the seat of the mould, has at least one peripheral end portion of the protruding portion which superposes a layer of the wrapper which is in direct contact with the material contained.

21. The process according to claim 15, wherein corresponding means are used designed for supplying vibrational mechanical energy to the wrapper with the material contained, in particular in the form of a respective sonotrode device, in particular operating on the wrapper with the material contained positioned inside a respective mould.

22. The process according to claim 15, wherein the wrapper, in particular before inserting in the mould, hermetically contains the material contained.

23. The process according to claim 22, wherein the wrapper comprises respective means for closing the portion of material inside the wrapper.

24. The process according to claim 22, wherein the closing means comprise one or more edges superposed and joined to each other of corresponding layers (14a, 14b) of the wrapper.

25. The process according to claim 22, wherein the closing means comprise a first and a second layer (14a, 14b) of wrapper having respective peripheral edges superposed and joined together.

26. The process according to claim 22, wherein the closing means comprise one or more edges superposed and joined to each other of the wrapper.

27. The process according to claim 15, wherein the closing means comprise respective end edges defined by portions superposed and joined together of the wrapper and a respective longitudinal edge which extends between and from the end edges and which is defined by lateral end portions superposed and joined together of the wrapper.

28. The process according to claim 15, wherein the energy supplied to the wrapper with the material contained is such as not to destroy or damage the wrapper.

29. The process according to claim 15, wherein vibrational mechanical energy is supplied to the wrapper with the material contained at a frequency of between 16,000 and 35,000 Hertz.

30. The process according to claim 15, wherein energy is supplied to the wrapper with the material contained at between 500 and 6000 Joules, preferably between 1200 and 3000 Joules.

31. The process according to claim 15, wherein energy is supplied to the wrapper with the material contained for a period of time between 0.5 and 20 seconds, and preferably between 2 and 6 seconds.

32. The process according to claim 15, wherein the portion of infusion material processed and inserted inside a specific wrapper has a weight of between 5 and 25 g.

33. The process according to claim 15, wherein the product is in the form of small pieces of tea leaves and/or camomile flowers and/or toasted and ground coffee powder or granules.

34. The process according to claim 15, wherein the wrapper is made of filtering film.

35. The process according to claim 15, wherein the wrapper is made of PLA.

36. The process according to claim 15, wherein a filtering film is used, preferably made of PLA, having a weight per square metre of between 80 mg and 110 mg.

37. The process according to claim 15, wherein a lower layer of the wrapper is prepared shaped in the form of a tray, that is, such as to define a respective seat for housing the food material in loose condition, and in that on this layer shaped like a tray, containing the food material in loose condition, is applied a respective sheet or layer, preferably flat, which is joined to the lower layer along the respective outer perimeter defining corresponding means of closing the package or wrapper.
